(19) United States
(12) Patent Application Publication
(10) Pub. No.: US 2011/0247137 A1
(43) Pub. Date: Oct. 13, 2011

(54) Siderail Accessory Module

(76) Inventors: Fred Herman, Cincinnati, OH (US); Thomas F. Heil, Batesville, IN (US); Charles A. Howell, Batesville, IN (US); Michelle Kovach, Batesville, IN (US); Timothy Stanley, Indianapolis, IN (US); Timothy J. Receveur, Guilford, IN (US); Josh Williams, Harrison, OH (US); John D. Christie, Batesville, IN (US); James L. Walke, Batesville, IN (US)

(21) Appl. No.: 13/082,748

(22) Filed: Apr. 8, 2011

Related U.S. Application Data
(60) Provisional application No. 61/322,400, filed on Apr. 9, 2010.

(51) Int. Cl. A47C 21/08; A47C 31/00; G08B 21/00; A47C 19/02; A61G 7/012; A47C 21/00; A47C 17/00

(52) U.S. Cl. 5/600; 5/503.1; 5/425; 340/540

(57) ABSTRACT

An apparatus comprises a housing and a communication system. The housing includes a front portion and a rear portion. The rear portion has an engagement surface and a coupler configured to cooperate with a portion of a person-support apparatus to removably couple the housing to the person-support apparatus. The communication system includes at least one communication device coupled to the housing. The communication device is configured to at least one of transmit and receive at least one of a data signal and a power signal to/from the person-support apparatus and an external device.

This Application claims priority to U.S. Provisional Application Ser. No. 61/322,400 titled SIDERAIL ACCESSORY MODULE filed on Apr. 9, 2010, the contents of which are incorporated herein by reference.

### BACKGROUND OF THE DISCLOSURE

This disclosure relates generally to communication systems. More particularly, but not exclusively, one illustrative embodiment relates to a communication system including an accessory module configured to be removably coupled to a person-support apparatus and configured to communicate at least one of a data signal and a power signal to/from a device in communication therewith.

People staying in hospitals can often bring electronic devices, such as, a music and/or video player, a mobile phone, a video game device, etc. The devices can be configured to communicate data/power signals and may need to be recharged from time to time for their effective use. While various communication systems have been developed, there is still room for improvement. Thus a need persists for further contributions in this area of technology.

### SUMMARY OF THE DISCLOSURE

In one illustrative embodiment, an accessory module configured to be coupled to a person-support apparatus includes a communication system configured to at least one of transmit and receive at least one of a data signal and a power signal to/from at least one of an external device and the person-support apparatus. In another illustrative embodiment, a kit can be provided including a rear portion, a first front portion of an accessory module configured to removably couple to the rear portion and perform a first function, a second front portion configured to removably couple to the rear portion and perform a second function, wherein the first function and the second function are different functions. In another illustrative embodiment, a communication system includes a controller configured to output a first signal received from an external device when a predetermined condition has not been satisfied and output an alert signal when the predetermined condition has been satisfied. In another illustrative embodiment, a lift system includes a lift system with a lift controller having an output device configured to output one or more of a predetermined voltage and a predetermined current to power a device coupled thereto.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout:

FIG. 1 is a perspective side view of a person-support apparatus with an accessory module coupled to a siderail according to one illustrative embodiment of the disclosure;

FIG. 2 is a perspective side view of the accessory module of FIG. 1 coupled to the siderail and positioned within a grip opening;

FIG. 3 is a perspective front view of the accessory module of FIG. 1 including a plurality of communication interfaces;

FIG. 4 is a side view of the accessory module of FIG. 1 showing a front portion and a coupling portion with a retainer and an engagement surface;

FIG. 5 is a diagrammatic view of the communication of data and/power signals between the person-support apparatus, accessory module, and external device according to one illustrative embodiment of the disclosure;

FIG. 6 is a side cross-sectional view of the accessory module according to one illustrative embodiment showing the communication system including a communication interface coupled to the bottom surface of the chamber and circuitry coupled to the communication interface via a cable;

FIG. 7 is a side cross-sectional view of the accessory module according to one illustrative embodiment showing a first contact coupled to the engagement surface and a second contact coupled to the siderail and configured to engage the first contact;

FIG. 8 is an exploded view of a kit including a plurality of different front portions configured to perform different function, a coupling portion, and a cable according to one illustrative embodiment of the disclosure; and

FIG. 9 is a partial schematic view of a signal priority system according to one illustrative embodiment of the disclosure.

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

In one illustrative embodiment, an accessory module configured to be coupled to a person-support apparatus includes a communication system configured to at least one of transmit and receive at least one of a data signal and a power signal to/from at least one of an external device and the person-support apparatus. In another illustrative embodiment, a kit can be provided including a rear portion, a first front portion of an accessory module configured to removably couple to the rear portion and perform a first function, a second front portion configured to removably couple to the rear portion and perform a second function, wherein the first function and the second function are different functions. In another illustrative embodiment, a communication system includes a controller configured to output a first signal received from an external device when a predetermined condition has not been satisfied and output an alert signal when the predetermined condition has been satisfied. In another illustrative embodiment, a lift system includes a lift system with a lift controller having an output device configured to output one or more of a predetermined voltage and a predetermined current to power a device coupled thereto.

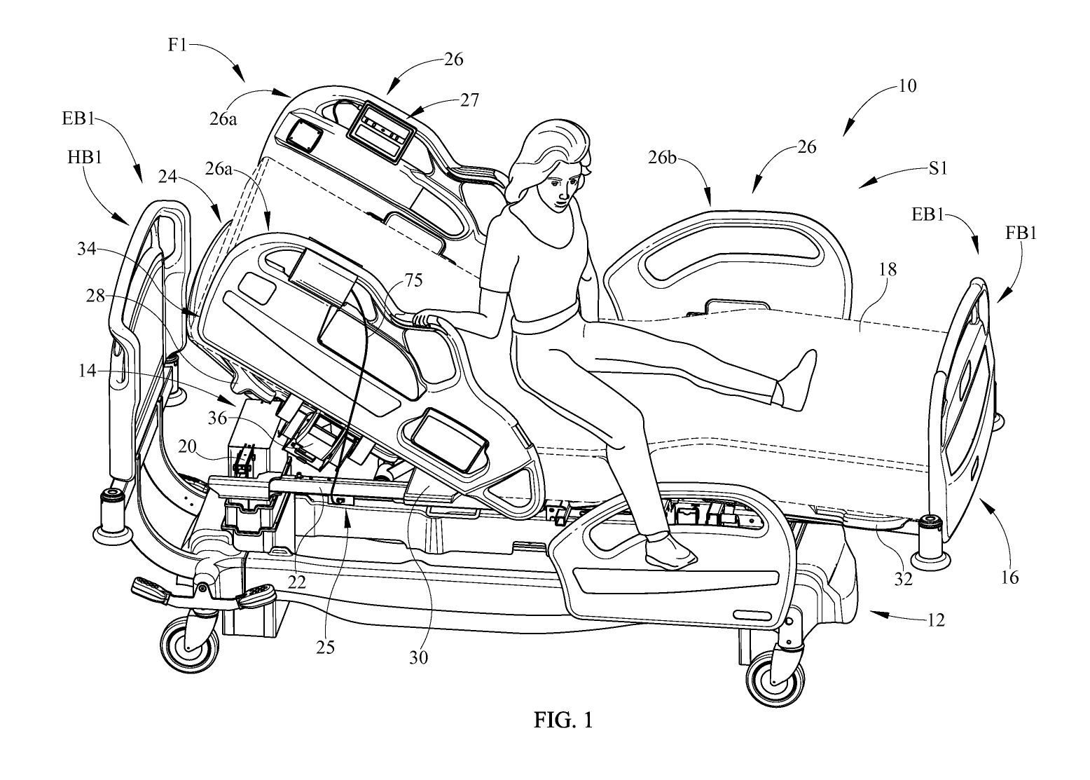

A person-support apparatus 10 according to one illustrative embodiment of the current disclosure is shown in FIG. 1. The person-support apparatus 10 can have a first section F1 or head support section F1, where the head of a person can be positioned and a second section S1 or a foot support section S1, where the feet of the person can be positioned. In one illustrative embodiment, the person-support apparatus 10 can be a hospital bed. It should be appreciated that the person-support apparatus 10 can also be a hospital stretcher or an operating table.

The person-support apparatus 10 can include a lower frame 12 or base 12, a plurality of supports 14 coupled with the lower frame 12, an upper frame 16 supported on the supports 14 above the lower frame 12, and a control system (not shown) configured to control at least one function of the person-support apparatus 10. It should be appreciated that the supports 14 can be lift mechanisms 14 that can move the upper frame 16 with respect to the lower frame 12. It should also be appreciated that the lift control system (not shown) can include a controller (not shown) that can have a dedicated output section configured to continuously output a predetermined voltage and current, which can be used to power devices and accessories coupled thereto and eliminate the need for the devices and accessories to be plugged into a wall power outlet (not shown). In one illustrative embodiment the person-support apparatus 10 can support a person-support surface 18 thereon.

The upper frame 16 can include an upper frame base 20, an intermediate frame 22, a deck 24, a data and/or power interface 25, siderails 26, and an accessory module 27 as shown in FIG. 1. It should be appreciated that the upper frame 16 can also include endboard EB1, such as, for example, a headboard HB1 and a footboard FB1, coupled to the first section F1 and the second section S1 of the person-support apparatus 10. The upper frame base 20 can be coupled to the supports 14 and can support the intermediate frame 22 and the deck 24 thereon as shown in FIG. 1. The deck 24 can be movably coupled to the intermediate frame 22 and can include a head portion 28, a seat portion 30, and a foot portion 32. The head portion 28, the seat portion 30, and the foot portion 32 can be movably coupled with each other and/or the intermediate frame 22.

The data and/or power interface 25 shown in FIG. 1 can be configured to transmit and/or receive a data signal and/or a power signal to/from a device or system coupled thereto, such as, the accessory module 27. In one illustrative embodiment, the data and/or power interface 25 can be an RS-232 serial port and can be configured to output about 8 V DC. It should be appreciated that the data and/or power interface 25 can be a USB interface port, parallel port, or other interface configured to transmit and/or receive the data signal and/or the power signal. It should also be appreciated that the data and/or power interface 25 can have separate data and power connectors (not shown). In another illustrative embodiment, the data and/or power interface 25 can be an AC power outlet. It should be appreciated that the AC power outlet can be connected to a converter configured to convert DC power to AC power. It should also be appreciated that the AC power outlet can receive AC power from a power system (not shown) of the person-support apparatus 10 that can be connected to an AC power outlet (not shown) in a room via a power cable (not shown).

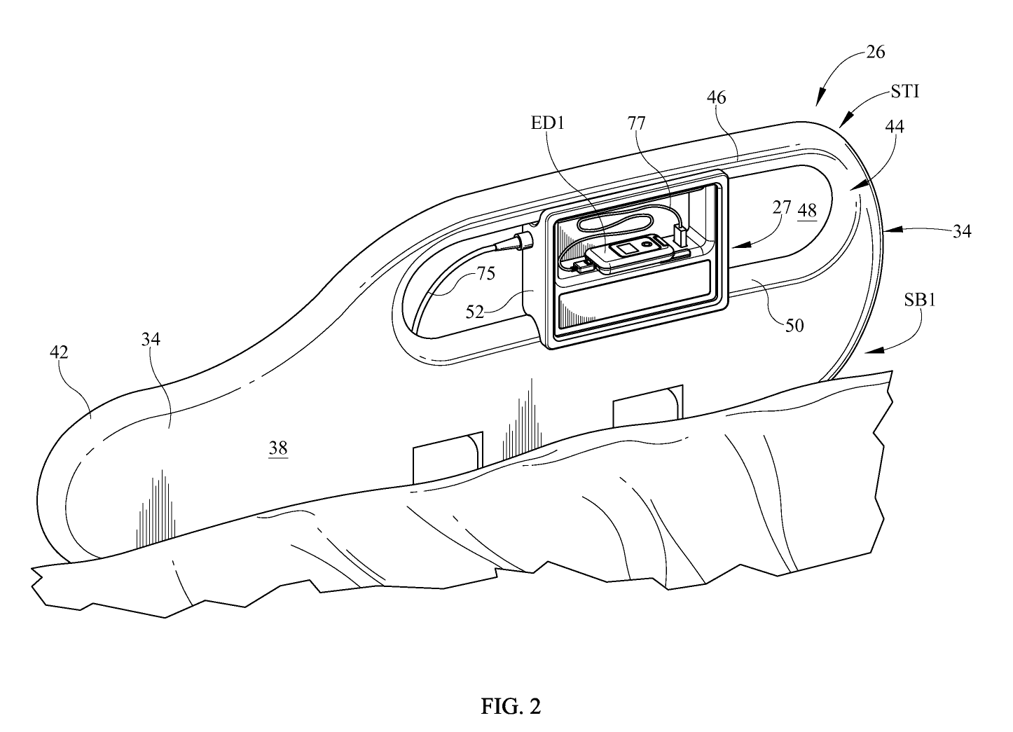

The siderails 26 can include a siderail body 34 with a top portion ST1 and a bottom portion SB1, and a siderail linkage 36 as shown in FIGS. 1 and 2. The siderail linkage 36 can be coupled to the bottom portion SB of the siderail body 34 and can couple the siderails 26 to the deck 24 and/or the intermediate frame 22. In one illustrative embodiment, the siderails 26 can be coupled to the head portion 28 of the deck 24 and/or intermediate frame 22 (i.e., a first siderail 26a or a head siderail 26a) and/or coupled to the foot portion 32 of the deck 24 and/or the intermediate frame 22 (i.e., a second siderail 26b or a foot siderail 26b) as shown in FIG. 1.

The siderail linkage 36 can be configured to facilitate movement of the siderails 26 between a deployed/operation position and a storage position as shown in FIG. 1. In the deployed/operation position, as shown in FIG. 1, at least a portion of the siderails 26 can be present above the upper frame 16. In the storage position, the siderails 26 can be moved to a lower position where at least a portion of the siderail 26 is below the deployed/operation position. It should be appreciated that the siderail linkage 36 can include a locking mechanism (not shown) that can maintain the siderails 26 in one of the operating and/or storage position when locked and can facilitate movement of the siderails 26 between the operating and storage position when unlocked.

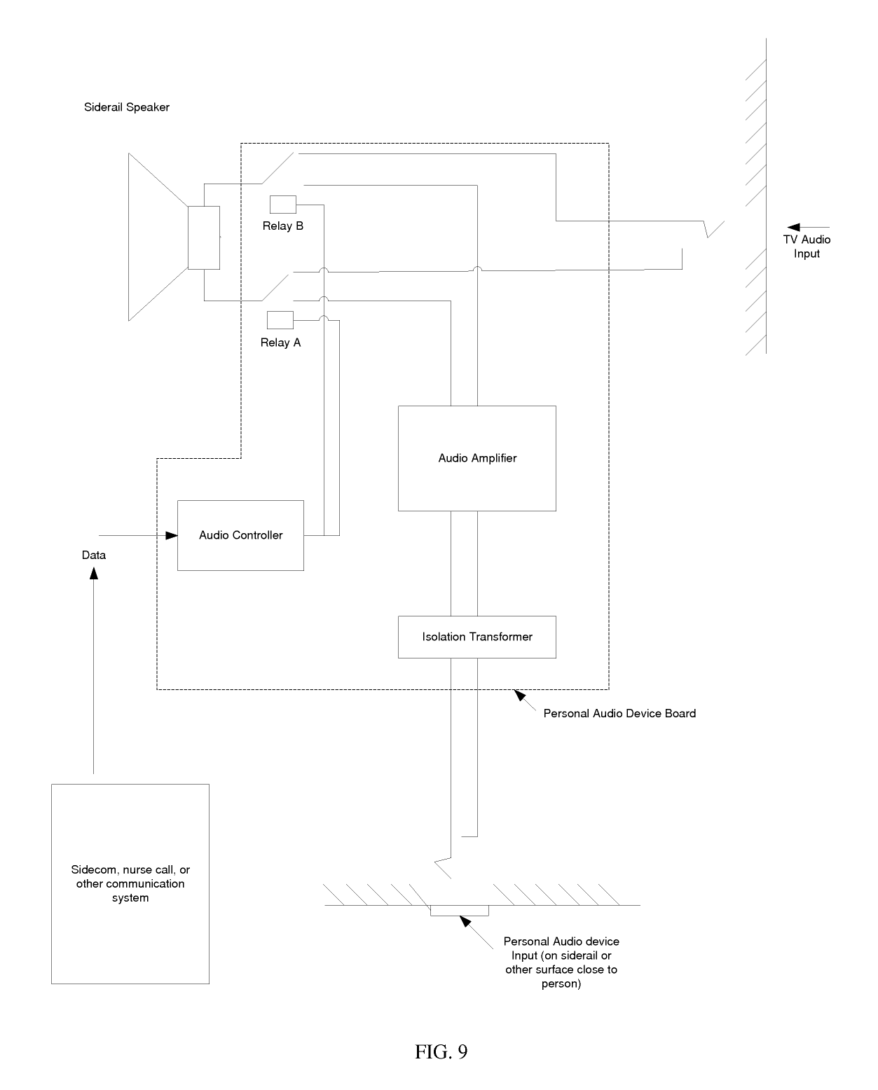

The siderail body 34 can include a first surface 38, a second surface 40, a side surface 42 extending between the first surface 38 and the second surface 40 and a grip portion 44 as shown in FIG. 2. It should be appreciated that the siderail 26 can include a person interface (not shown), such as, for example, a graphical user interface, that can be in communication with the control system to selectably control various functionalities of the person-support apparatus 10. It should also be appreciated that the siderail 26 can include speakers (not shown) configured to output audio signals generated by a media device or a nurse call system (not shown), which can be given priority over audio signals generated by the media device by switching channels via relays when nurse call is in use as shown in FIG. 9. At least a portion of the first surface 38 and the second surface 40 can be substantially parallel to one another. The first surface 38 can be oriented such that the first surface 38 faces toward the upper frame 16 and the second surface 40 can be oriented such that the second surface 40 faces away from the upper frame 16.

The grip portion 44 shown in FIG. 2 can be configured to be gripped by a person to assist the person with ingress/egress to/from the person support apparatus 10. In one illustrative embodiment, the grip portion 44 can be located along the top portion ST1 and can include a grip 46 and a grip opening 48. The grip opening 48 can pass through the siderail body 34 and be configured to allow a person to wrap at least a portion of their fingers/hand around the grip 46. In one illustrative embodiment, an upper portion of the grip opening 48 can define the bottom of the grip 46 and a lower portion of the grip opening 48 opposite the upper portion of the grip opening 48 can define a portion of the upper side surface 50.

The accessory module 27 or removable module 27 can be configured to be positionable within the grip opening 48 as shown in FIGS. 1-2. It should be appreciated that the accessory module 27 can be removably coupled to at least one endboard EB1. In one illustrative embodiment, the accessory module 27 can include a thermoelectric cup holder configured to heat and/or cool a cup held by the cup holder. In another illustrative embodiment, the accessory module 27 can include a display (not shown) and at least one audio output device (not shown), such as, a speaker (not shown), that can be configured to output images and audio signals, respectively, from the external device ED1, person-support apparatus 10, and/or external system in communication therewith. It should be appreciated that the speakers can be positioned in the siderail 26. It should be appreciated that the display can be pivotably mounted within the housing so that it can be rotated for a better viewing angle. It should also be appreciated that the volume controls (not shown) can be mounted on the accessory module 27. It should also be appreciated that the mount for the display can expand, contract, and swivel to orient the display as desired.

In still another illustrative embodiment, the accessory module 27 can be configured to transmit, receive, read, and/or write a data signal and/or a power signal to/from a signal storage device (not shown) and/or processor (not shown) in communication therewith. The signal storage device can be a power storage device and/or a memory device in an external device ED1 and/or the person-support apparatus 10. It should be appreciated that the accessory module 27 can transmit and/or receive a data signal and/or a power signal to/from a remote system (not shown) in communication with the accessory module 27, such as, a hospital network (not shown) and/or a caregiver interface, such as, a nurse station, nurse call interface, remote alert device, and/or an electronic medical device. The external device ED1 can be at least one of a music and/or video player, such as, for example, an iPod, a mobile phone and/or smart phone, an electronic game device, an electronic personal organizer, or other personal electronic devices. It should be appreciated that the external device ED1 can store information, such as, for example, electronic medical records (EMR) and/or patient information, including preferences, that can be communicated from the external device ED1 to an EMR system, a nurse call system, and/or other system or location, and downloaded to the external device ED1 from the EMR system, the nurse call system, and/or other systems or locations.

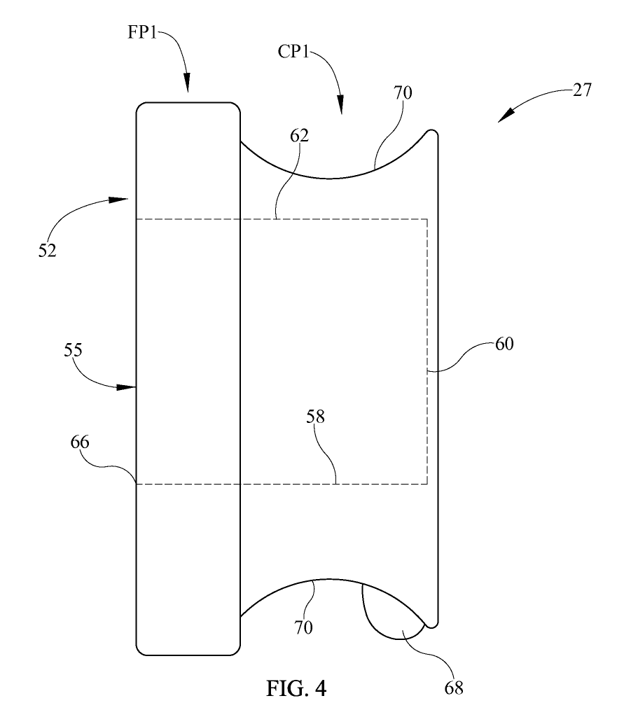

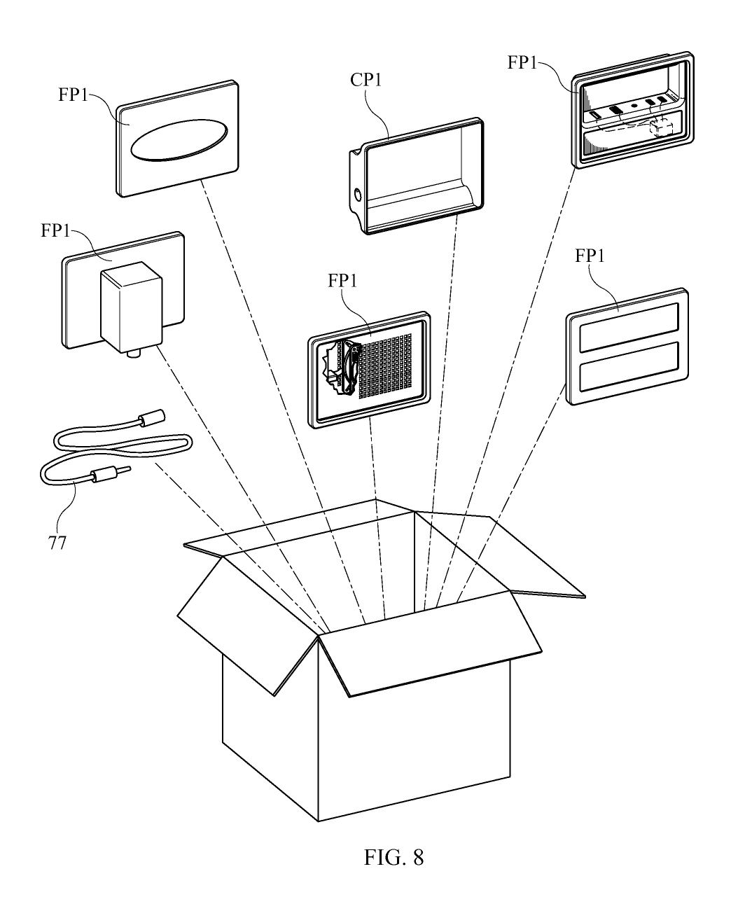

The accessory module 27 can include a housing 52 and a communication system 54 as shown in FIGS. 2-4 & 6-7. The housing 52 can be formed of a polymeric material and can be removably coupled to the person-support apparatus 10. The housing 52 can include a coupling portion CP1 and front portion FP1 as shown in FIG. 4. It should be appreciated that the housing 52 can also include a back portion (not shown) that can be removably coupled to the coupling portion such that the back portion cooperates with the front portion FP1 and the coupling portion CP1 to couple the accessory module 27 to the person-support apparatus 10. In one illustrative embodiment, the front portion FP1 can be removably couplable to the coupling portion CP1. It should be appreciated that the front portion FP1 can be part of a kit including multiple front portions FP1 configured to cooperate with the coupling portion CP1 to serve different purposes and/or perform different functions, such as, for example, storage, antimicrobial dispensing, tissue dispensing, cooling and/or heating, and/or other purposes and functions as shown in FIG. 8.

The housing 52 shown in FIGS. 2-4 & 6-7 can be configured to extend less than a predetermined distance beyond a plane extending along the first surface 38. It should be appreciated that the housing 52 can be configured to extend greater than or less than the predetermined distance when coupled to an endboard EB1 or other portion of the person-support apparatus 10. It should also be appreciated that the housing 52 can be configured to extend greater than the predetermined distance from the plane formed by the second surface 40. In one illustrative embodiment, the thickness of the siderail 26 with the accessory module 27 coupled thereto is less than about 3 inches. In another illustrative embodiment, the thickness of the coupling portion CP1 can be equal to about the thickness of the grip 46.

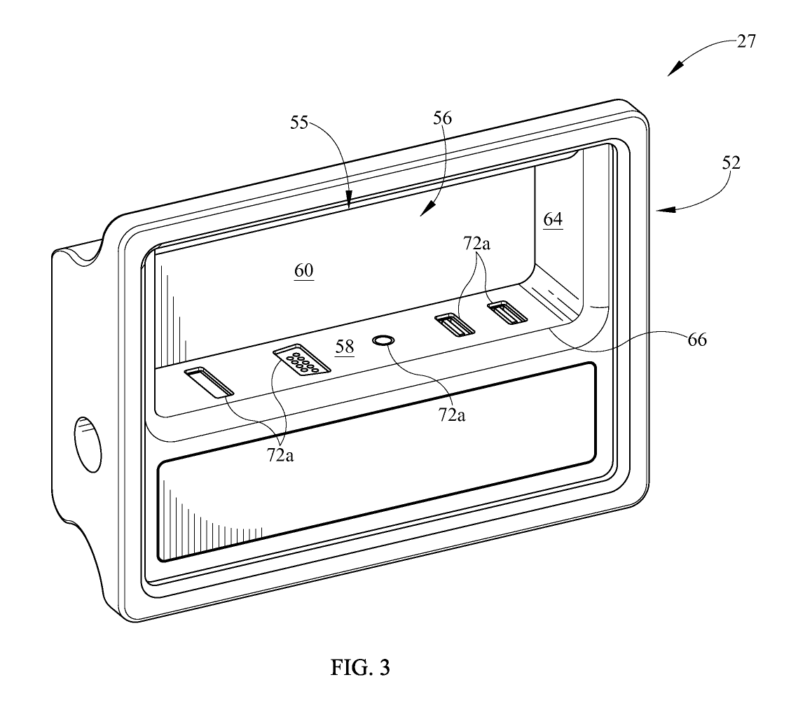

The front portion FP1 of the housing 52 can include an opening 55 into a chamber 56 having a bottom surface 58, a rear surface 60, a top surface 62, and a plurality of side surfaces 64 shown in FIGS. 3-4 & 6. The side surface 64 can extend from about a front edge 66 of the bottom surface 58 to the rear surface 60, and from the bottom surface 58 to the top surface 62. The bottom surface 58 can be configured to support at least one external device ED1 thereon. It should be appreciated that the bottom surface 58 can be configured to removably retain the external device ED1 by way of a raised portion (not shown) along the front edge 66. It should also be appreciated that the external device ED1 can be retained on the bottom surface 58 with other fasteners or retainers (not shown). It should also be appreciated that the bottom surface 58 can be used for storage of both electronic devices and non-electronic devices.

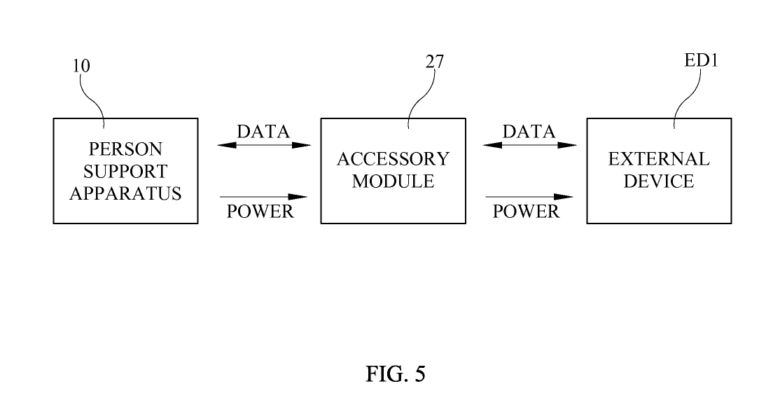

The coupling portion CP1 can include a retainer 68 and engagement surfaces 70 as shown in FIGS. 4-7. In one illustrative embodiment, the retainer 68 can be a spring actuated mechanism that can be slidably or pivotably coupled to the housing 52 and movable relative to the housing 52 between extended and depressed or compressed positions. In another illustrative embodiment, the accessory module 27 can be configured to be press-fit or snapped into the grip opening 48. In still another embodiment, the retainer 68 can be a flexible tab (not shown) that can be deflected when inserting the housing 52 into the grip opening 48 and return to a substantially non-deflected state to provide a snap fit and couple the accessory module 27 within the grip opening 48. It should be appreciated that the accessory module 27 can be removed by pushing or pulling the accessory module 27 in the opposite direction from which it was press-fit or snapped in.

In yet another illustrative embodiment, the accessory module 27 can be configured to couple to at least one end board EB1. In still other embodiments, the accessory module 27 can be coupled to the siderails 26 and/or the end boards EB1 with hangers, hooks, clamps, fasteners (not shown), such as, screws, interlocking members, or other fastening elements. It should be appreciated that the accessory module 27 can be generally rectangular in shape. It should be further appreciated that the accessory module 27 can have antimicrobial properties.

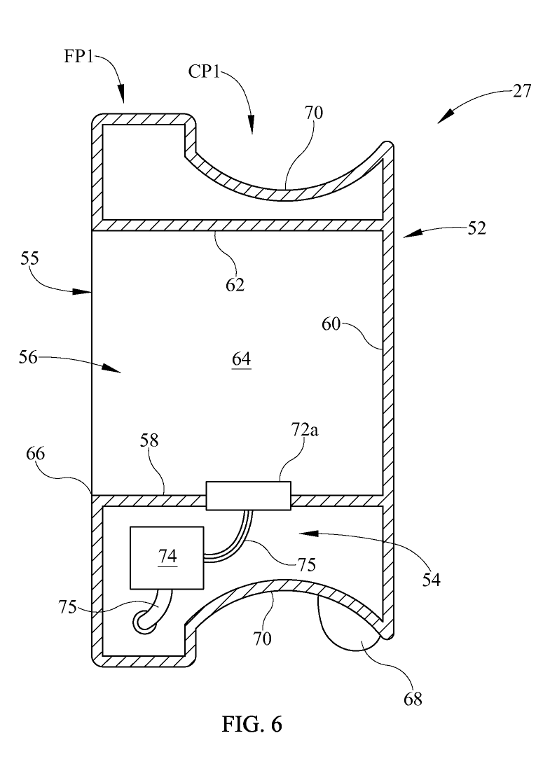

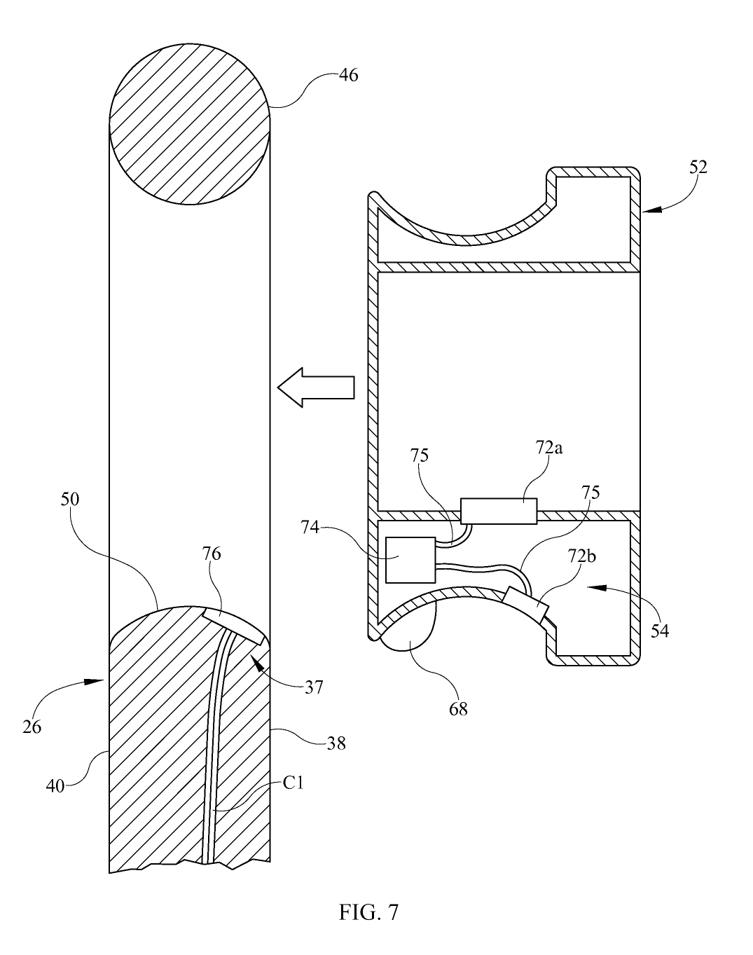

The communication system 54 shown in FIGS. 6-7 can be configured to transmit receive, read, and/or write a data signal and/or a power signal to/from the signal storage device and/or processor. The communication system 54 can include at a plurality of external device interfaces 72a and 72b and circuitry 74 positioned within the housing 51. It should be appreciated that the communication system 54 can include only one external device interface 72 configured to communicate with at least one external device ED1 and/or person-support apparatus 10. It should also be appreciated that the siderails 26 can include external device interfaces (not shown) like the external device interfaces 72 thereon that can be configured to couple to the signal storage device and transmit/receive/read/write a signal to/from the signal storage device. The communication system 54 can be configured to communicate a data signal and/or a power signal to/from the external device ED1 and/or the person-support apparatus 10 through a wired connection and/or a wireless connection.

The circuitry 74 shown in FIGS. 6-7 can be electrically coupled to the external device interfaces 72a and 72b and can facilitate communication of data and/or power therebetween. In one illustrative embodiment, the circuitry 74 can include at least one cable 75 connecting the external device interfaces 72a and 72b. It should be appreciated that the cable 75 can connect the external device interface 72a directly to the data and/or power interface 25. It should be appreciated that the cable 75 can connect other components of the circuitry 74 to the data and/or power interface 25. It should also be appreciated that the cable 75 can be connected to an AC adapter (not shown) removably coupled to a power outlet (not shown) in the room to power the accessory module 27, which can eliminate the need to isolate the electronics in the accessory module 27 from the electronics in the person-support apparatus 10. It should also be appreciated that the cable 75 can connect the external device interface 72a directly to the dedicated output of the controller of the lift control system.

In another illustrative embodiment, the circuitry 74 can include a controller (not shown) configured to control communication of data and/or power between the external device interfaces 72a and 72b, the external device ED1, and/or the person-support apparatus 10. In yet another illustrative embodiment, the circuitry 74 can be configured to regulate the voltage and/or current received from the person-support apparatus 10 such that the voltage and/or current transmitted to the external device ED1 is at a predetermined level, such as, for example, about 5 VDC. It should be appreciated that the predetermined level can be more or less than 5 VDC. In yet another illustrative embodiment, the circuitry 74 can include an analog to digital (A/D) and/or a digital to analog (D/A) converter. It should be appreciated that the circuitry 74 can include other digital and/or analog signal converters, shifters, encrypters and/or encoders, decrypters and/or decoders, or other digital and/or analog signal modifying hardware and/or software.

In yet another illustrative embodiment, the circuitry 74 can include a power source (not shown), such as, for example, a battery, configured to supply power to the external device ED1 and/or various components of the accessory module 27. In still another illustrative embodiment, the circuitry 74 can include a wireless power transmitter and/or receiver (not shown) configured to transmit and/or receive power wirelessly to/from the external device and/or the person-support apparatus 10. It should be appreciated that the circuitry 74 can include an indicator light (not shown) configured to emit light when the accessory module 27 is transmitting and/or receiving a data signal and/or a power signal from at least one of the person-support apparatus 10 and external device ED1.

The external device interfaces 72 shown in FIGS. 3 & 6-7 can be a wired and/or wireless device configured to transmit and/or receive a data signal and/or a power signal to/from the external device ED1 and/or person-support apparatus 10. In a wired configuration, the external device interfaces 72 can be physically connected to the external device ED1 and/or the person-support apparatus 10. In one illustrative embodiment, the external device interfaces 72 can be a plurality of contacts 76 configured to engage corresponding contacts on the external device ED1 and/or person-support apparatus 10 (as shown in FIG. 7). It should be appreciated that individual contacts can be configured to communicate one or both of data and power. In one example, the electrical contacts 76 can be positioned along the engagement surfaces 70 and at least one of the bottom of the grip 46 and the upper side surface 50 when the accessory module 27 is coupled to the siderail 26. In another example, the retainer 68 can include electrical contacts that can engage corresponding electrical contacts on at least one of the bottom of the grip 46 and the upper side surface 50 when the accessory module 27 is coupled to the siderail 26.

In another illustrative embodiment, the external device interfaces 72 can be a receptacle, such as, for example, a universal serial bus (USB) interface, located on the bottom surface 58 that can be configured to receive a first end of a cable 77, the second end of which can be configured to connect to the external device ED1 and/or the person-support apparatus 10 as shown in FIGS. 2-3 & 6-7. It should be appreciated that the external device interfaces 72 can receive a connector integrated into the external device ED1. It should also be appreciated that the external device interfaces 72 can be an AC power outlet that can be connected to a converter configured to convert DC power to AC power, or can receive AC power from a power system (not shown) of the person-support apparatus 10 that can be connected to an AC power outlet (not shown) in a room via a power cable (not shown). It should also be appreciated that the cables 77 can be a group of cables supplied with the accessory module 27 in a kit with each cable 77 having a connector on the first end configured to couple to the external device interfaces 72, and at least one connector on the second end, which can be different than the connector on the first end, that can be configured to couple to different external devices ED1. It should also be appreciated that a kit can be provided including at least one cable 77, at least one front portion FP1, and/or a coupling portion CP1. It should also be appreciated that the external device interfaces 72 can be other sockets, plugs, and connectors, including, but not limited to, component video connectors, fiber optic connectors, cigarette lighter type sockets, serial and/or parallel communication ports, or other electrical connections. It should also be appreciated that the external device interfaces 72 can be located on any surface of the housing 51. It should also be appreciated that the external device interfaces 72 can be configured to include separate power and data communication interfaces.

In a wireless configuration, the external device interfaces 72 shown in 3 & 6-7 can communicate a data signal and/or a power signal to/from the external device ED1 and/or the person-support apparatus 10 regardless of whether the accessory module 27 is coupled to the person-support apparatus 10. In one illustrative embodiment, the external device interfaces 72 can be a Bluetooth wireless transceiver configured to transmit and/or receive data to/from the external device ED1, the person-support apparatus 10, and/or a remote system (not shown). It should be appreciated that the data signal and/or the power signal can be communicated using other wireless techniques, such as, radio frequency (RF), infrared (IR), inductive coupling, or other forms of wireless data transmission/reception and/or near field/far field wireless power transmission techniques. It should also be appreciated that the remote system can be a hospital network, nurse call system, and/or other remote systems. In another illustrative embodiment, the external device interfaces 72 can be an inductive arrangement configured to charge a power source (not shown) in the external device ED1 while the external device is positioned on the bottom surface 58. It should be appreciated that the inductive arrangement can include a portion located within the housing 52 and a portion positioned on the person-support apparatus 10.

Many other embodiments of the present disclosure are also envisioned. For example, an apparatus comprises a housing and a communication system. The housing includes a front portion and a rear portion. The rear portion has an engagement surface and a coupler configured to cooperate with a portion of a person-support apparatus to removably couple the housing to the person-support apparatus. The communication system includes at least one communication device coupled to the housing. The communication device is configured to at least one of transmit and receive at least one of a data signal and a power signal to/from the person-support apparatus and an external device. In one illustrative embodiment, the housing is configured to removably couple to a grip portion of a siderail coupled to the person-support apparatus. In another example, the grip portion includes a grip opening, at least a portion of the housing being positionable within the grip opening when the housing is coupled to the siderail. In another illustrative embodiment, the housing is configured to removably couple to a grip portion of an endboard coupled to the person-support apparatus. In another illustrative embodiment, the communication device is configured to communicate with at least one of the external device and the person-support apparatus via a cable coupled to the communication device and the at least one of the external device and the person-support apparatus. In another illustrative embodiment, the communication device is configured to communicate wirelessly with at least one of the external device and the person-support apparatus. In another illustrative embodiment, the housing includes an opening into a chamber, the chamber being defined by a bottom surface, a top surface, a plurality of side surfaces, and a back surface. The bottom surface is configured to support the external device thereon. In another illustrative embodiment, the communication device is a universal serial bus (USB) connector. In another illustrative embodiment, the communication system receives power from the person-support apparatus. In another illustrative embodiment, the communication system includes a power source positioned within the housing. In another illustrative embodiment, the communication system includes electronic circuitry configured to manipulate at least one of the data signal and the power signal at least one of transmitted and received to/from at least one of the external device and the person-support apparatus. In another illustrative embodiment, the communication system includes electronic circuitry configured to influence at least one of the transmission and the receipt of at least one of the data signal and the power signal to/from at least one of the external device and the person-support apparatus. In another illustrative embodiment, the external device is a personal electronic device. In another illustrative embodiment, the external device is at least one of a cellular phone, an electronic storage device, an electronic organizing device, and an electronic media playing device. In another illustrative embodiment, the communication system is configured to wirelessly recharge a power source within the external device. In another illustrative embodiment, the engagement surface is configured to engage at least one of a siderail and an endboard coupled to the person-support apparatus. The engagement surface includes a first electrical contact and at least one of the siderail and the endboard including a second electrical contact configured to engage the first electrical contact when the apparatus is coupled to the at least one of the siderail and the endboard.

In another example, a siderail assembly comprises a siderail and an accessory module. The siderail includes a body with a perimeter edge and a grip portion. The grip portion includes a grip opening that cooperates with the perimeter edge to define a grip. The accessory module is configured to removably couple to the siderail. The accessory module includes a housing and communication system with a communication interface coupled to the housing. The communication device is configured to at least one of transmit and receive at least one of a data signal and a power signal to/from an external device. In one illustrative embodiment, the siderail is coupled to a person-support apparatus, the communication device is configured to at least one of transmit and receive at least one of the data signal and the power signal to/from the person-support apparatus. In another illustrative embodiment, at least a portion of the housing is positionable within the grip opening when the accessory module is coupled to the siderail. In another illustrative embodiment, the housing includes an engagement surface configured to mimic the contour of the grip. In another illustrative embodiment, the communication device is configured to communicate with the external device via a cable coupled to the communication device and the external device. In another illustrative embodiment, the communication device is configured to communicate wirelessly with the external device. In another illustrative embodiment, the housing includes an opening into a chamber. The chamber is defined by a bottom surface, a top surface, a plurality of side surfaces, and a back surface. The bottom surface is configured to support the external device thereon. In another illustrative embodiment, the communication system includes a power source positioned within the housing. In another illustrative embodiment, the external device is a personal electronic device. In another illustrative embodiment, the external device is at least one of a cellular phone, an electronic storage device, an electronic organizing device, and an electronic media playing device. In another illustrative embodiment, the communication system is configured to wirelessly recharge a power source positioned within the external device. In another illustrative embodiment, the housing includes a front portion and a rear portion. The rear portion includes an engagement surface and a coupler, the engagement surface is configured to engage the grip portion. The engagement surface includes a first electrical contact and the siderail includes a second electrical contact configured to engage the first electrical contact when the apparatus is coupled to the siderail.

In another example, a kit, comprises a first front portion of an accessory module housing, a second front portion of an accessory module housing, and a third front portion of an accessory module housing. The first front portion of the accessory module housing is configured to removably couple to a rear portion of an accessory module housing and is configured to cooperate with the rear portion to define a storage area. The second front portion of the accessory module housing is configured to removably couple to a rear portion of an accessory module housing. The second front portion includes an antimicrobial container configured to dispense at least one of an antimicrobial substance and a material substantially saturated with an antimicrobial substance. The third front portion of the accessory module housing is configured to removably couple to a rear portion of the accessory module housing and is configured to at least one of transmit and receive at least one of a data signal and a power signal to/from at least one of a person-support apparatus and an external device. In one illustrative embodiment, the kit further comprises a connector cable. In another illustrative embodiment, the kit further comprises a rear portion. The rear portion is configured to removably engage at least one of a siderail and an endboard of a person-support apparatus. In another illustrative embodiment, at least a portion of the rear portion is configured to be positioned within a grip opening in the at least one of the siderail and the endboard. In another illustrative embodiment, the third front portion is configured to at least one of transmit and receive at least one of the data signal and the power signal wirelessly. In another illustrative embodiment, the kit further comprises a fourth front portion of an accessory module housing configured to removably couple to a rear portion of the accessory module housing and configured to generate a flow of air.

In another example, a kit comprises at least one rear portion of an accessory module housing, a first front portion of an accessory module housing, and a second a front portion of an accessory module housing. The first front portion of the accessory module housing is configured to be removably coupled to the rear portion and configured to perform a first function. The second front portion of the accessory module housing is configured to be removably coupled to the rear portion. The second front portion is configured to perform a second function, wherein the first function and the second function are different functions. In one illustrative embodiment, one of the first front portion and the second front portion is configured to dispense at least one of an antimicrobial substance and a material substantially saturated with an antimicrobial substance. In another illustrative embodiment, one of the first front portion and the second front portion is configured to cooperate with the rear portion to define a storage area. In another illustrative embodiment, one of the first front portion and the second front portion is configured to at least one of transmit and receive at least one of a data signal and a power signal to/from an external device. In another illustrative embodiment, one of the first front portion and the second front portion is configured to generate a flow of air.

In another example, a communication system for a person-support apparatus comprises a frame, a siderail, and a communication device. The siderail is coupled to the frame. The communication device is coupled to the siderail and configured to communicate a signal to a signal storage device coupled thereto. In one illustrative embodiment, the signal storage device stores power. In another illustrative embodiment, the signal storage device stores data.

In another example, a communication system for a person-support apparatus comprises a frame, a siderail, and a communication device. The siderail is coupled to the frame. The communication device is coupled to the siderail and configured to communicate a signal to a processor coupled thereto.

In another example, an apparatus comprises a housing and a communication system. The housing includes a front portion and a rear portion. The rear portion has an engagement surface and a coupler configured to cooperate with a portion of a person-support apparatus to removably couple the housing to the person-support apparatus. The communication system includes at least one communication device coupled to the housing. The communication device is configured to electrically couple to at least one of a person-support apparatus, a signal storage device, and a signal processing device and communicate at least one of a data signal and a power signal therebetween. In one illustrative embodiment, the communication device is configured to electrically couple to at least two of a person-support apparatus, a signal storage device, and a signal processing device and communicate at least one of a data signal and a power signal therebetween.

In another example, a siderail assembly comprises a siderail and an accessory module. The siderail includes a body with a perimeter edge and a grip portion. The grip portion includes a grip opening that cooperates with the perimeter edge to define a grip. The accessory module is configured to be removably couple to the siderail. The accessory module includes a housing and communication system with a communication interface coupled to the housing. The communication device is configured to electrically couple to at least one of a person-support apparatus, a signal storage device, and a signal processing device and communicate at least one of a data signal and a power signal therebetween.

In still another example, a communication system for a person-support apparatus comprises an output device, an input device, an alert system, and a controller. The input device is configured to receive a first signal from an external device. The alert system is configured to generate an alert signal when a predetermined condition has been satisfied. The controller is configured to output the first signal through the output device when the predetermined condition has not been satisfied and output the alert signal through the output device when the predetermined condition has been satisfied. In one illustrative embodiment, the output device is a loudspeaker. In another illustrative embodiment, the input device is a connector configured to connect to the external device via a cable. In another illustrative embodiment, the input device is configured to receive the first signal wirelessly. In another illustrative embodiment, the alert system is a nurse call system. In another illustrative embodiment, the external device is configured to output an audio signal. In another illustrative embodiment, the controller outputs the first signal after the alert signal has been output. In another illustrative embodiment, the output device is a display screen. In another illustrative embodiment, the external device is configured to output a video signal. In another illustrative embodiment, the output device is coupled to a siderail of the person-support apparatus. In another illustrative embodiment, the person-support apparatus is a bed. In another illustrative embodiment, the input device is coupled to a siderail of the person-support apparatus.

In still another example, a lift system for a person-support apparatus comprises a lift assembly, a lift motor, and a lift controller. The lift motor is configured to move the lift assembly. The lift controller is configured to control the operation of the lift motor. The lift controller includes an output device configured to output one or more of a predetermined voltage and predetermined current to power a device coupled thereto.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. An apparatus, comprising:
a housing including a front portion and a rear portion, the rear portion having an engagement surface and a coupler configured to cooperate with a portion of a person-support apparatus to removably couple the housing to the person-support apparatus; and
a communication system including at least one communication device coupled to the housing, the communication device being configured to at least one of transmit and receive at least one of a data signal and a power signal to/from the person-support apparatus and an external device.

2. The apparatus of claim 1, wherein the housing is configured to removably couple to a grip portion of a siderail coupled to the person-support apparatus.

3. The apparatus of claim 2, wherein the grip portion includes a grip opening, at least a portion of the housing being positionable within the grip opening when the housing is coupled to the siderail.

4. The apparatus of claim 1, wherein the housing is configured to removably couple to a grip portion of an endboard coupled to the person-support apparatus.

5. The apparatus of claim 1, wherein the communication device is configured to communicate with at least one of the external device and the person-support apparatus via a cable coupled to the communication device and the at least one of the external device and the person-support apparatus.

6. The apparatus of claim 1, wherein the communication device is configured to communicate wirelessly with at least one of the external device and the person-support apparatus.

7. The apparatus of claim 1, wherein the housing includes an opening into a chamber, the chamber being defined by a bottom surface, a top surface, a plurality of side surfaces, and a back surface, the bottom surface being configured to support the external device thereon.

8. The apparatus of claim 1, wherein the communication device is a universal serial bus (USB) connector.

9. The apparatus of claim 1, wherein the communication system receives power from the person-support apparatus.

10. The apparatus of claim 1, wherein the communication system includes a power source positioned within the housing.

11. The apparatus of claim 1, wherein the communication system includes electronic circuitry configured to manipulate at least one of the data signal and the power signal at least one of transmitted and received to/from at least one of the external device and the person-support apparatus.

12. The apparatus of claim 1, wherein the communication system includes electronic circuitry configured to influence at least one of the transmission and the receipt of at least one of the data signal and the power signal to/from at least one of the external device and the person-support apparatus.

13. The apparatus of claim 1, wherein the external device is a personal electronic device.

14. The apparatus of claim 1, wherein the external device is at least one of a cellular phone, an electronic storage device, an electronic organizing device, and an electronic media playing device.

15. The apparatus of claim 1, wherein the communication system is configured to wirelessly recharge a power source within the external device.

16. The apparatus of claim 1, wherein the engagement surface is configured to engage at least one of a siderail and an endboard coupled to the person-support apparatus, the engagement surface including a first electrical contact and at least one of the siderail and the endboard including a second electrical contact configured to engage the first electrical contact when the apparatus is coupled to the at least one of the siderail and the endboard.

17. A siderail assembly, comprising:
a siderail including a body with a perimeter edge and a grip portion, the grip portion including a grip opening that cooperates with the perimeter edge to define a grip; and
an accessory module configured to removably couple to the siderail, the accessory module including a housing and communication system with a communication interface coupled to the housing, the communication device being configured to at least one of transmit and receive at least one of a data signal and a power signal to/from an external device.

18. The siderail assembly of claim 17, wherein the siderail is coupled to a person-support apparatus, the communication device being configured to at least one of transmit and receive at least one of the data signal and the power signal to/from the person-support apparatus.

19. The siderail assembly of claim 17, wherein at least a portion of the housing is positionable within the grip opening when the accessory module is coupled to the siderail.

20. The siderail assembly of claim 19, wherein the housing includes an engagement surface configured to mimic the contour of the grip.

20. The siderail assembly of claim 17, wherein the communication device is configured to communicate with the external device via a cable coupled to the communication device and the external device.

21. The siderail assembly of claim 17, wherein the communication device is configured to communicate wirelessly with the external device.

22. The siderail assembly of claim 17, wherein the housing includes an opening into a chamber, the chamber being defined by a bottom surface, a top surface, a plurality of side surfaces, and a back surface, the bottom surface being configured to support the external device thereon.

23. The siderail assembly of claim 17, wherein the communication system includes a power source positioned within the housing.

24. The siderail assembly of claim 17, wherein the external device is a personal electronic device.

25. The siderail assembly of claim 17, wherein the external device is at least one of a cellular phone, an electronic storage device, an electronic organizing device, and an electronic media playing device.

26. The siderail assembly of claim 17, wherein the communication system is configured to wirelessly recharge a power source positioned within the external device.

27. The siderail assembly of claim 17, wherein the housing includes a front portion and a rear portion, the rear portion includes an engagement surface and a coupler, the engagement surface is configured to engage the grip portion, the engagement surface includes a first electrical contact and the siderail includes a second electrical contact configured to engage the first electrical contact when the apparatus is coupled to the siderail.

28. A kit, comprising:
at least one rear portion of an accessory module housing;
a first front portion of an accessory module housing configured to be removably coupled to the rear portion and configured to perform a first function; and
a second front portion of an accessory module housing configured to be removably coupled to the rear portion, the second front portion being configured to perform a second function, wherein the first function and the second function are different functions.

29. The kit of claim 28, wherein one of the first front portion and the second front portion is configured to dispense at least one of an antimicrobial substance and a material substantially saturated with an antimicrobial substance.

30. The kit of claim 28, wherein one of the first front portion and the second front portion is configured to cooperate with the rear portion to define a storage area.

31. The kit of claim 28, wherein one of the first front portion and the second front portion is configured to at least one of transmit and receive at least one of a data signal and a power signal to/from an external device.

32. The kit of claim 28, wherein one of the first front portion and the second front portion is configured to generate a flow of air.

33. A communication system for a person-support apparatus, comprising:
an output device;
an input device configured to receive a first signal from an external device;
an alert system configured to generate an alert signal when a predetermined condition has been satisfied; and
a controller being configured to output the first signal through the output device when the predetermined condition has not been satisfied and output the alert signal through the output device when the predetermined condition has been satisfied.

34. A lift system for a person-support apparatus, comprising:
a lift assembly;
a lift motor configured to move the lift assembly; and
a lift controller configured to control the operation of the lift motor; the lift controller including an output device configured to output one or more of a predetermined voltage and predetermined current to power a device coupled thereto.
